(19) United States
(12) Patent Application Publication
(10) Pub. No.: US 2013/0158728 A1
(43) Pub. Date: Jun. 20, 2013

(54) APPARATUS AND METHOD FOR SAVING ENERGY IN BUILDING BASED ON ONTOLOGY

(71) Applicant: Electronics and Telecommunications Research Institute, Daejeon-city (KR)

(72) Inventors: Hyun-Jeong LEE, Daejeon (KR); Jin-Soo HAN, Daejeon (KR); Youn-Kwae JEONG, Daejeon (KR); Il-Woo LEE, Daejeon (KR)

(73) Assignee: Electronics and Telecommunications Research Institute, Daejeon-city (KR)

(21) Appl. No.: 13/716,949

(22) Filed: Dec. 17, 2012

(30) Foreign Application Priority Data
Dec. 20, 2011 (KR) 10-2011-0138578
Jul. 4, 2012 (KR) 10-2012-0072600

(51) Int. Cl. G05B 19/02

(52) U.S. Cl. CPC G05B 19/02
USPC 700/286

(57) ABSTRACT

Disclosed herein are an apparatus and method for saving energy in a building. The apparatus for saving energy in a building includes an interface unit, a building information definition unit, an ontology representation unit, and an energy management unit. The interface unit receives the external and internal contexts and characteristics of the building from a building information provision module within the building. The building information definition unit defines the external and internal contexts and characteristics of the building as building information using a specific representation format. The ontology representation unit represents the building information in a form of an ontology model. The energy management unit selects an energy management service based on an ontology model corresponding to the current context and characteristics of the building received via the interface unit, and saves energy in the building based on the selected energy management service.

### CROSS-REFERENCE TO RELATED APPLICATIONS

This application claims the benefit of Korean Patent Application Nos. 10-2011-0138578 and 10-2012-0072600, filed on Dec. 20, 2011 and Jul. 4, 2012, respectively, which are hereby incorporated by reference in their entirety into this application.

### BACKGROUND OF THE INVENTION

1. Technical Field

The present invention relates generally to an apparatus and method for saving energy in a building based on ontology and, more particularly, to an apparatus and method that represent building information including the internal and external contexts and characteristics of a building in the form of ontology and save energy in the building based on the ontology.

2. Description of the Related Art

In general, methods of saving energy through direct human manipulation, such as a case in which a human turns off lights by manipulating one or more switches on a wall when leaving a room, are widely applied to buildings. These energy saving methods involving the manipulation of one or more switches have the problem of low usefulness when a human does not remember to use the method because he or she is personally required to manipulate the switches.

For example, Korean Patent Application Publication No. 2011-0038979 entitled “Energy Consumption Control Method based on Energy Consumption Model” is intended to optimize the consumption of energy in a space in which energy is used based on the variety of context information of a user. While the technology disclosed in the publication allows the static and dynamic information of the user to be applied to ontology, it has the disadvantage of failing to take into account dynamically changing contexts, such as weather outside a building.

### SUMMARY OF THE INVENTION

Accordingly, the present invention has been made keeping in mind the above problems occurring in the prior art, and an object of the present invention is to provide an apparatus and method that represent building information including the internal and external contexts and characteristics of a building in the form of ontology and save energy in the building based on the ontology.

In order to accomplish the above object, the present invention provides an apparatus for saving energy in a building, including an interface unit configured to receive external and internal contexts and characteristics of the building from a building information provision module within the building; a building information definition unit configured to define the external and internal contexts and characteristics of the building as building information using a specific representation format; an ontology representation unit configured to represent the building information as an ontology model; and an energy management unit configured to select an energy management service based on an ontology model corresponding to the current contexts and characteristic of the building received via the interface unit, and to save energy in the building based on the selected energy management service.

The ontology model may correspond to the results of modeling a building energy policy for saving of energy, the building information, and an energy management service based on the building information.

The ontology model may include a sensor layer configured to collect and manage internal information including the internal context and characteristics of the building and external information including the external context and characteristics of the building; a context layer configured to extract a context from the internal and external information, and to select an energy management service based on a building energy policy corresponding to the selected context; and a service layer configured to provide the energy management service selected by the context layer to the energy management unit as the ontology model.

The context layer may map the extracted context to the energy management service, and contain the results of the mapping in a table form.

The building information definition unit may use a Building Information Modeling (BIM) format and a Green Building XML (gbXML) format.

In order to accomplish the above object, the present invention provides a method of saving energy in a building, including receiving external and internal contexts and characteristics of the building from a building information provision module within the building; defining the external and internal contexts and characteristics of the building as building information using a specific representation format; representing the building information as an ontology model; extracting an ontology model corresponding to the current context and characteristics of the building; and applying an energy management service, corresponding to the extracted ontology model, to the building.

The ontology model may correspond to results of modeling a building energy policy for saving of energy, the building information, and an energy management service based on the building information.

The ontology model may include a sensor layer configured to collect and manage internal information including the internal context and characteristics of the building and external information including the external context and characteristics of the building; a context layer configured to extract a context from the internal and external information, and to select an energy management service based on a building energy policy corresponding to the selected context; and a service layer configured to provide the energy management service selected by the context layer to the energy management unit as the ontology model.

The context layer may map the extracted context to the energy management service, and contain results of the mapping in a table form.

Defining the external and internal contexts and characteristics of the building as building information may include using a BIM format and a gbXML format.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing the configuration of an energy saving service environment to which an apparatus for saving energy in a building based on ontology according to an embodiment of the present invention is applied;

FIG. 2 is a diagram showing the configuration of the apparatus for saving energy in a building based on ontology according to the embodiment of the present invention;

FIG. 3 is a flowchart showing a method of saving energy in a building based on ontology according to an embodiment of the present invention; and

FIG. 4 is a diagram schematically showing a building energy saving ontology model according to an embodiment of the present invention.

### DESCRIPTION OF THE PREFERRED EMBODIMENTS

The present invention will be described in detail below with reference to the accompanying drawings. Repeated descriptions and descriptions of known functions and constructions which have been deemed to make the gist of the present invention unnecessarily vague will be omitted below. The embodiments of the present invention are provided in order to fully describe the present invention to a person having ordinary knowledge in the art. Accordingly, the shapes, sizes, etc. of elements in the drawings may be exaggerated to make the description clear.

An apparatus and method for saving energy in a building based on ontology according to embodiments of the present invention will be described in detail below with reference to the accompanying drawings.

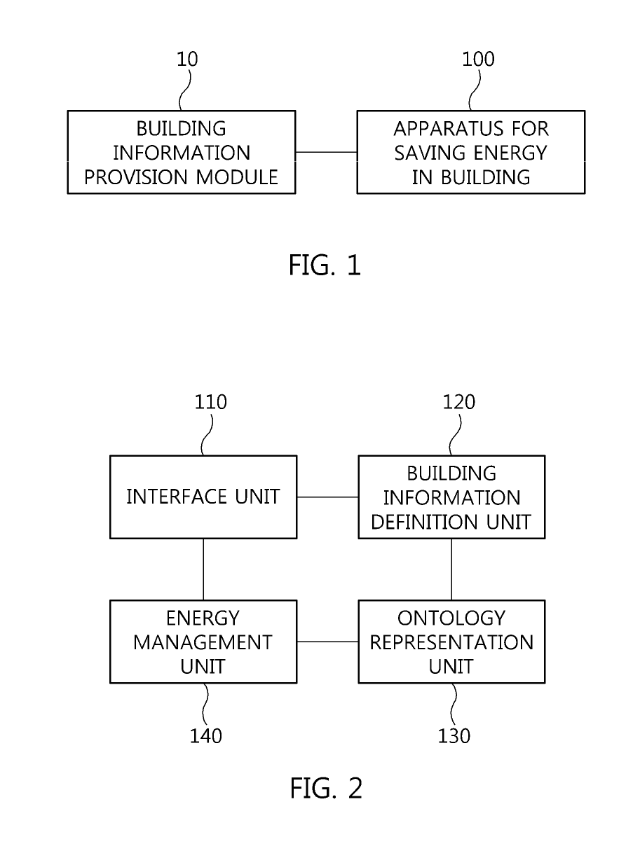

FIG. 1 is a diagram schematically showing the configuration of an energy saving service environment to which an apparatus 100 for saving energy in a building based on ontology according to an embodiment of the present invention is applied. Furthermore, FIG. 2 is a diagram showing the configuration of the apparatus 100 for saving energy in a building based on ontology according to the embodiment of the present invention.

Referring to FIG. 1, the energy saving service environment includes a building (not shown), and a building information provision module 10 and the apparatus 100 for saving energy in a building within the building.

The building information provision module 10 provides the external and internal context and characteristics of the building to the apparatus 100 for saving energy in a building.

The apparatus 100 for saving energy in a building receives building information from the building information provision module 10 within a building, defines the received building information, represents the results of the definition in the form of ontology, and manages energy in the building, thereby saving energy in the building.

Referring to FIG. 2, the apparatus 100 for saving energy in a building includes an interface unit 110, a building information definition unit 120, an ontology representation unit 130, and an energy management unit 140.

The interface unit 110 receives the external and internal context and characteristics of the building from the building information provision module 10 within the building, and transfers a corresponding energy control signal to a central control system (not shown) within the building. Here, the energy control signal is a control signal that corresponds to an energy management service that is selected by the energy management unit 140.

The building information definition unit 120 defines the external and internal context and characteristics of the building received for a set period via the interface unit 110 as building information.

The building information definition unit 120 may define data received for a previously set period as building information using BIM and gbXML, but is not limited thereto. Here, BIM is a technique that designs the overall process of architecture, including planning, design, engineering (structure, facility, electrics, etc.), construction, management, and dismantlement, in virtual space using a three-dimensional computer program, and can reduce the construction cost because it enables an error in design and a problem with construction to be found in advance, compared to conventional two-dimensional design. Meanwhile, gbXML is a building representation format that was developed to be used as a common interoperability model into which a number of design and developing tools used in the building-related industry had been integrated, and has been integrated with a software Computer-Aided Design (CAD) and engineering tool.

The building information according to an embodiment of the present invention may be defined as internal information including the internal context and characteristics of a building and external information including the external context and characteristics of the building.

The internal information includes static building structural information, dynamic building usage information, and facility information.

The static building structural information is information that corresponds to the purpose, location, area, total number of floors, appearance, name, and year of completion of the building, the areas of spaces and the relationships of inclusion of the spaces within a building, and so on. The dynamic building usage information is information that corresponds to the number of persons residing in the building, the schedules of the persons residing in the building, the status of the reservation of a conference room, working hours, the number of working days, heating and cooling days, set heating and cooling temperatures, and so on.

The facility information is information about the boiler, water heating and cooling apparatus, ventilation, lighting, power, gas, Fan Coil Units (FCUs), windows, doors, blinds, sensors and the like of the building.

The external information includes weather information and Internet information.

The weather information is information that corresponds to weather at the location of the building, for example, external air weather, cloud coverage, temperature, humidity and so on.

The Internet information corresponds to information acquired over the Internet, for example, building-related service, apps, material, and news articles.

The ontology representation unit 130 represents the results of the definition performed by the building information definition unit 120, that is, building information, in the form of ontology.

The form of ontology according to an embodiment of the present invention corresponds to a model that is intended to provide an optimized energy management service using building information, and the results of modeling a building energy policy for saving of energy, building information, and a service based on the building information, that is, an ontology model.

For example, the ontology model may configure building information for each of layers, such as a sensor layer, a context layer, and a service layer.

The sensor layer is a layer that collects and manages internal information including the internal context and characteristics of the building and external information including the external context and characteristics of the building.

The context layer extracts a context from the internal information and the external information, and selects an energy management service based on a building energy policy corresponding to the extracted contexts. Thereafter, the context layer maps the extracted context to the energy management service, and contains the results of the mapping in the form of a table.

The service layer is a layer that provides the energy management service selected by the context layer to the energy management unit 140 in the form of ontology.

The energy management unit 140 selects the energy management service corresponding to the context and characteristics of the current building received from the interface unit 110 at the ontology representation unit 130, and may save the energy in the building based on the selected energy management service.

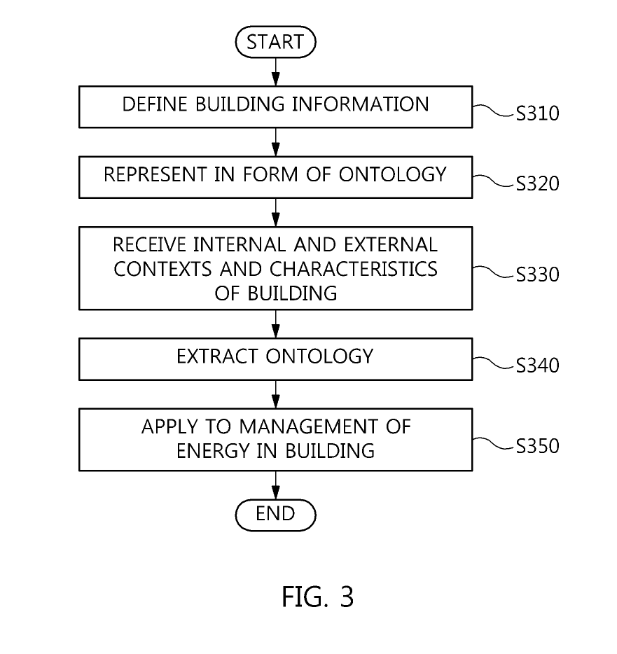

Next, a method of saving energy in a building based on ontology will be described in detail below with reference to FIG. 3.

FIG. 3 is a flowchart showing the method of saving energy in a building based on ontology according to the embodiment of the present invention.

Referring to FIG. 3, the apparatus 100 for saving energy in a building defines the external and internal context and characteristics of a building received for a set period as building information at step S310.

The apparatus 100 for saving energy in a building represents the building information defined at step S310 in the form of ontology at step S320. Here, the form of ontology according to an embodiment of the present invention corresponds to a model that is intended to provide an optimized energy management service using building information, and the results of modeling a building energy policy for saving of energy, building information, and a service based on the building information, that is, an ontology model. For example, the ontology model may configure building information for each of layers, such as a sensor layer, a context layer, and a service layer.

The sensor layer is a layer that collects and manages internal information including the internal context and characteristics of the building and external information including the external context and characteristics of the building.

The context layer extracts a context from the internal information and the external information, and selects an energy management service based on a building energy policy corresponding to the extracted contexts. Thereafter, the context layer maps the extracted context to the energy management service, and contains the results of the mapping in the form of a table.

The service layer is a layer that provides the energy management service selected by the context layer to the energy management unit 140 in the form of ontology.

The apparatus 100 for saving energy in a building receives the internal and external contexts and characteristics of the current building at step S330.

At step S340, the apparatus 100 for saving energy in a building extracts an ontology model corresponding to the context and characteristics of the current building received at S330.

The apparatus 100 for saving energy in a building applies an energy management service corresponding to the ontology model extracted at step S340 to the management of energy in the building at step S350.

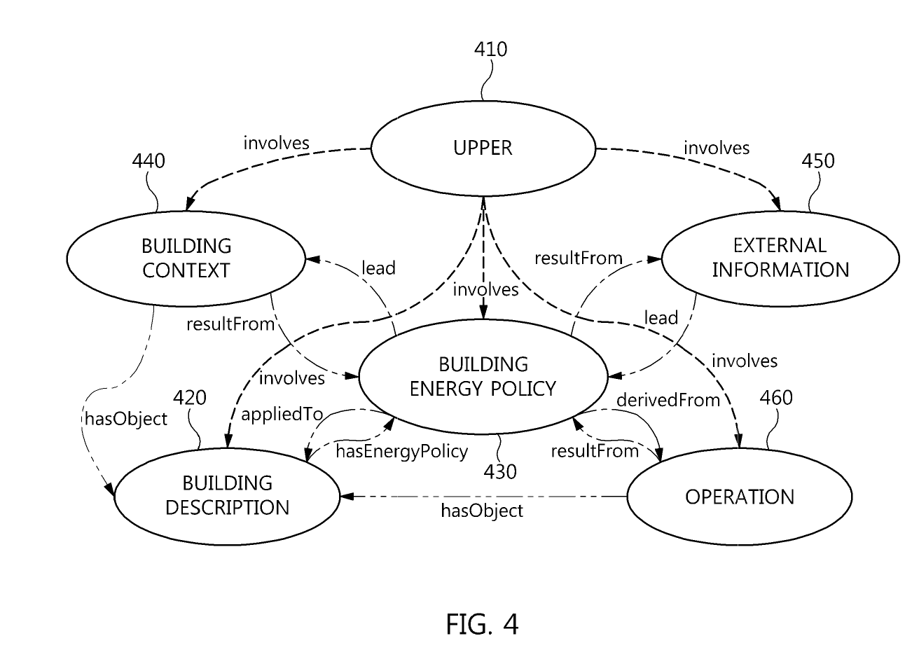

Next, the ontology model will be described in detail below with reference to FIG. 4.

FIG. 4 is a diagram schematically showing a building energy saving ontology model according to an embodiment of the present invention.

Referring to FIG. 4, the ontology model includes an upper module 410, a building description module 420, a building energy policy module 430, a building context information module 440, an external information module 450, and an operation module 460. The ontology model may be illustrated in the following Table 1:

TABLE 1

| Module | Contents and Scope |
|---|---|
| Upper | a level including all (for example, an entity, and so on) |
| Building | a description of a building (for example, |
| Description | a building object, a building space, and so on) |
| | hierarchical configuration of building components (for |
| | example, a building -> a floor -> a zone, . . . ) |
| | the restrictive characteristics of the building |
| | (for example, the presence or absence of a BAS, |
| | the presence or absence of an elevator, and so on) |
| Building Energy | a set of rules related to a building energy policy |
| Policy | construct energy saving rules |
| | (rule -> condition -> action -> predicate) |
| Building Context | a real-time instance data layer |
| | data abstraction (data -> situation -> context) |
| | execute energy saving rules |
| External | weather, schedule, time |
| Information | execute energy saving rules |
| Operation | execution operation |
| | representation in gbXML format |

According to the embodiments of the present invention, the apparatus and method for saving energy in a building based on ontology automatically control the lighting, power, heating and cooling, and the like of a building using the central control system based on ontology corresponding to building information depending on the real-time internal and external contexts of the building, thereby saving energy in the building.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for saving energy in a building, comprising:
an interface unit configured to receive external and internal contexts and characteristics of the building from a building information provision module within the building;
a building information definition unit configured to define the external and internal contexts and characteristics of the building as building information using a specific representation format;
an ontology representation unit configured to represent the building information in a form of an ontology model; and
an energy management unit configured to select an energy management service based on an ontology model corresponding to current context and characteristics of the building received via the interface unit, and to save energy in the building based on the selected energy management service.

2. The apparatus of claim 1, wherein the ontology model corresponds to results of modeling a building energy policy for saving of energy, the building information, and an energy management service based on the building information.

3. The apparatus of claim 1, wherein the ontology model comprises:
a sensor layer configured to collect and manage internal information including the internal context and characteristics of the building and external information including the external context and characteristics of the building;
a context layer configured to extract a context from the internal and external information, and to select an energy management service based on a building energy policy corresponding to the selected context; and
a service layer configured to provide the energy management service selected by the context layer to the energy management unit as the ontology model.

4. The apparatus of claim 3, wherein the context layer maps the extracted context to the energy management service, and contains results of the mapping in a table form.

5. The apparatus of claim 1, wherein the building information definition unit uses a Building Information (BIM) format and a Green Building XML (gbXML) format.

6. A method of saving energy in a building, comprising:
receiving external and internal contexts and characteristics of the building from a building information provision module within the building;
defining the external and internal contexts and characteristics of the building as building information using a specific representation format;
representing the building information in a form of an ontology model;
extracting an ontology model corresponding to current context and characteristics of the building; and
applying an energy management service, corresponding to the extracted ontology model, to the building.

7. The method of claim 6, wherein the ontology model corresponds to results of modeling a building energy policy for saving of energy, the building information, and an energy management service based on the building information.

8. The method of claim 6, wherein the ontology model comprises:
a sensor layer configured to collect and manage internal information including the internal context and characteristics of the building and external information including the external context and characteristics of the building;
a context layer configured to extract a context from the internal and external information, and to select an energy management service based on a building energy policy corresponding to the selected context; and
a service layer configured to provide the energy management service selected by the context layer to the energy management unit as the ontology model.

9. The method of claim 8, wherein the context layer maps the extracted context to the energy management service, and contains results of the mapping in a table form.

10. The method of claim 6, wherein defining the external and internal contexts and characteristics of the building as building information comprises using a BIM format and a gbXML format.
